(19) United States
(12) Patent Application Publication
(10) Pub. No.: US 2017/0332666 A1
(43) Pub. Date: Nov. 23, 2017

(54) APPLICATION OF P-METHYL BENZOIC ACID OR SALTS THEREOF AS ADDITIVES FOR ANIMAL FEED

(71) Applicant: GUANGZHOU INSIGHTER BIOTECHNOLOGY CO., LTD., Guangzhou, Guangdong (CN)

(72) Inventors: Xianfeng Peng, Guangzhou (CN); Zonghua QIN, Guangzhou (CN)

(73) Assignee: GUANGZHOU INSIGHTER BIOTECHNOLOGY CO., LTD., Guangzhou, Guangdong (CN)

(21) Appl. No.: 15/535,715

(22) PCT Filed: Mar. 18, 2015
(86) PCT No.: PCT/CN2015/074469

§ 371 Date: Jun. 14, 2017

(30) Foreign Application Priority Data
Feb. 16, 2015 (CN) 201510092452.1

(51) Int. Cl. A23K 20/20; A23K 20/22; A23K 50/80; A23K 20/111

(52) U.S. Cl. CPC A23K 20/20; A23K 20/111; A23K 20/22; A23K 50/80

(57) ABSTRACT

An Application of p-methyl benzoic acid or a salt thereof as an additive for a feed or fed into drinking water for animals such as pigs, broilers, ducks, aquatic animals or other farmed animals, for preventing diarrhea and promoting growth, wherein p-methyl benzoic acid or a salt thereof is a type of acidifying agents for growth promotion.

### CROSS-REFERENCE TO RELATED APPLICATIONS

This is a U.S. national stage application of the International Patent Application No. PCT/CN2015/074469, filed Mar. 18, 2015, which claims priority to Chinese Patent Application No. 201510092452.1, filed Feb. 16, 2015, both of which are incorporated herein by reference in their entireties.

### FIELD OF THE INVENTION

This invention relates to the field of livestock and poultry cultivation, particularly, for example, the present invention relates to use of p-methyl benzoic acid or salts thereof as additives or acidifying agents for feed.

### BACKGROUND OF THE INVENTION

An acidifying agent for feed is a widely used additive type for a feed in the art. However, the actual effect of an inorganic acid or an organic acid in terms of acid supplement on use for animals is not validated, that is, it's actually unable to reduce the digesta pH in the gastrointestinal tract of young pig or other animals.

### SUMMARY OF THE INVENTION

In one aspect, provided herein is use of p-methyl benzoic acid or a salt thereof as an additive for a feed for animal. In some embodiments, the additive for the feed for animal disclosed herein is a growth promoter for animal. In further embodiments, the additive for the feed for animal disclosed herein is an acidifying agent.

In certain embodiments, the salt disclosed herein is a salt of p-methyl benzoic acid selected from calcium, zinc, sodium, or potassium salt. In further embodiments, the calcium salt of p-methyl benzoic acid is a salt with p-methyl benzoic acid and calcium in a ratio of 2:1 by mole; the zinc salt of p-methyl benzoic acid is a salt with p-methyl benzoic acid and zinc in a ratio of 2:1 by mole; the sodium salt of p-methyl benzoic acid is a salt with p-methyl benzoic acid and sodium in a ratio of 1:1 by mole; the potassium salt of p-methyl benzoic acid is a salt with p-methyl benzoic acid and potassium in a ratio of 1:1 by mole.

In some embodiments, the animal is pig, chicken, duck, or an aquatic animal.

In certain embodiments, the concentration of p-methyl benzoic acid or a salt thereof in the feed for animal is from 1 ppm to 20000 ppm. In some embodiments, the concentration of p-methyl benzoic acid or a salt thereof in the feed for animal is from 250 ppm to 10000 ppm.

In some embodiments, the use comprises adding p-methyl benzoic acid or a salt thereof into animal drinking water for animals to drink, and the concentration of p-methyl benzoic acid or a salt thereof is from 250 ppm to 10000 ppm.

### DETAILED DESCRIPTION OF THE INVENTION

In one aspect, provided herein is use of p-methyl benzoic acid or a salt thereof as an additive for a feed for animal.

In some embodiments, it is found that p-methyl benzoic acid (or its calcium, zinc, sodium, or potassium salt) with the concentration from 1 ppm to 20000 ppm used as an additive for a feed for pigs functions as preventing diarrhea and promoting growth through experiments and tests, and the effect is distinctly better than that of the commonly used inorganic or organic acidifying agent with equal concentration.

In addition, the present disclosure is first discovered that p-methyl benzoic acid or its calcium, zinc, sodium, or potassium salt can be used in a feed for chickens, aquatic animals and all other farmed animals, to improve the production performance.

Thus, certain embodiments of the present invention provide use of p-methyl benzoic acid or a salt thereof as an additive for a feed, for example, as an acidifying agent for a feed, more particular, certain embodiments of the present invention provide use of p-methyl benzoic acid or a salt thereof as a growth promoter for a feed for animal.

In some embodiments, the salt is a salt of p-methyl benzoic acid selected from calcium, zinc, sodium, or potassium salt.

In some embodiments, the calcium salt of p-methyl benzoic acid is a salt with p-methyl benzoic acid and calcium in a ratio of 2:1 by mole; the zinc salt of p-methyl benzoic acid is a salt with p-methyl benzoic acid and zinc in a ratio of 2:1 by mole; the sodium salt of p-methyl benzoic acid is a salt with p-methyl benzoic acid and sodium in a ratio of 1:1 by mole; the potassium salt of p-methyl benzoic acid is a salt with p-methyl benzoic acid and potassium in a ratio of 1:1 by mole.

In some embodiments, the animal is preferable pig, broiler chicken, duck, an aquatic animal and the like.

In some embodiments, the concentration of p-methyl benzoic acid or a salt thereof in the feed for animal is from 1 ppm to 20000 ppm, preferably from 250 ppm to 5000 ppm.

In some embodiments, the feed for animal is preferably a complete formula feed.

In some embodiments, the use disclosed herein comprises adding p-methyl benzoic acid or its calcium, zinc, sodium, or potassium salt into animal drinking water for animals to drink, and the concentration of p-methyl benzoic acid or its calcium, zinc, sodium, or potassium salt is from 250 ppm to 10000 ppm.

The present disclosure proved that use of p-methyl benzoic acid or a salt thereof as an additive for a feed or fed into drinking water for pigs, broiler chickens, ducks, aquatic animals and other farmed animals, which has unique advantages for preventing diarrhea and promoting growth through a series of experiments and tests, furthermore, p-methyl benzoic acid or a salt thereof is an acidifying agent that is effective for growth promotion and has a very good prospect for use in cultivation industry; its performance is distinctly superior to that of any other publicly reported acidifying agents for feed.

### EXAMPLE S

For further descriptions of the present invention, the following examples and test examples are presented, but these examples and test examples should not be construed to limit the scope of the invention.

### Example 1

### 1.1 Synthesis of Calcium p-methyl Benzoate

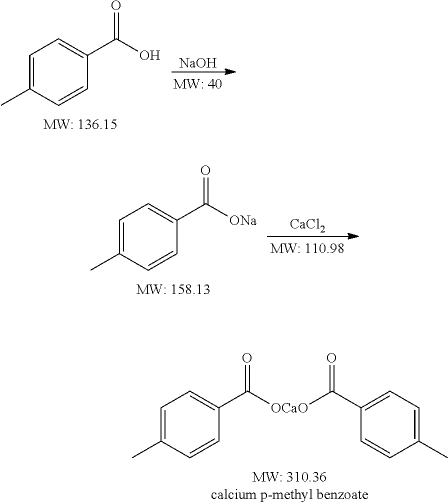

To a stirred solution of water (300 mL) and sodium hydroxide (96%, 4.17 g, 0.1 mole, 1 eq) in 1 L of flask was added p-methyl benzoic acid (13.6 g, 0.1 mole, 1 eq) at room temperature. The reaction mixture was allowed to stir for 1.5 hours. After complete dissolution of the starting materials, the reaction mass was stirred for a further 30 min, then a solution of anhydrous calcium chloride (96%, 5.73 g, 0.05 mole, 0.5 eq) in 100 mL of water was added dropwise over a period of about 10 min and the resulting reaction mixture was stirred for another 4 hours. The solid was collected by filtration and washed with water three times, and then oven dried at 80° C. for 8 hours to afford the title compound calcium p-methyl benzoate as a white solid. The synthesis scheme is shown above.

### 1.2 Synthesis of Sodium p-methyl Benzoate

To a stirred solution of water (300 mL) and sodium hydroxide (4.0 g) in 1 L of flask was added p-methyl benzoic acid (13.6 g) at room temperature. The reaction mixture was allowed to stir for 1.5 hours. After complete dissolution of the starting materials, the reaction mixture was concentrated in vacuo to afford sodium p-methyl benzoate as a white solid.

### 1.3 Synthesis of Potassium p-methyl Benzoate

To a stirred solution of water (300 mL) and potassium hydroxide (5.6 g) in 1 L of flask was added p-methyl benzoic acid (13.6 g) at room temperature. The reaction mixture was allowed to stir for 1.5 hours. After complete dissolution of the starting materials, the reaction mixture was concentrated in vacuo to afford potassium p-methyl benzoate as a white solid.

### 1.4 Synthesis of Zinc p-methyl Benzoate

To a stirred solution of water (300 mL) and sodium hydroxide (4.0 g) in a 1 L of flask was added p-methyl benzoic acid (13.6 g) at room temperature. The reaction mixture was allowed to stir for 1.5 hours. After complete dissolution of the starting materials, the reaction mixture was stirred for a further 30 minutes, then a solution of zinc sulfate heptahydrate (14.4 g) in 200 mL of water was added dropwise over a period of about 10 min and the resulting reaction mixture was stirred for another 4 hours. The solid was collected by filtration and washed with water three times, and then oven dried at 80° C. for 8 hours to afford zinc p-methyl benzoate as a white solid.

### Example 2

### Effects of p-methyl Benzoic Acid and its Salts in the Feed for Weaned Pigs

140 weaned Duroc×Landrace×Large White piglets aged 28 days with similar body weight and further having an average body weight of 7.61 kg were divided into 14 groups, each with 10 pigs. After adding different concentrations of p-methyl benzoic acid or its calcium, sodium, potassium or zinc salt prepared by the embodiments disclosed herein into the conventional creep feed (excluding acidifying agent) of each group, the pigs were free feeding and drinking during the test period of 10 days, then to collect statistics of the weight gain and the feed conversion ratio as well as the diarrhea rate of test pig in each test group. The test results are shown in Table 2, it can be seen that the group of p-methyl benzoic acid or its calcium salt with the concentration of 2000 ppm can significantly reduce the diarrhea rate of test pigs, and has a significant dose effect on the improvement of production performance. Nevertheless, the group of phosphoric acid or citric acid with the concentration of 2000 ppm has no such effects, and the rate of anti-diarrhea of benzoic acid with equal concentration is increased slightly as compared to phosphoric acid or citric acid. Thus, the groups or p-methyl benzoic acid and its calcium salt, sodium salt, potassium salt and the like each with the concentration from 10000 ppm to 20000 ppm can significantly reduce the diarrhea rate of test pigs, and have a significant dose effect on the improvement of the production performance.

TABLE 1
Grouping of growth promotion test of weaned pigs with different
concentrations of acidifying agents, p-methyl benzoic acid or its
calcium, sodium, potassium or zinc salt.

| | Number | | Concentration |
|---|---|---|---|
| Group | of animals | Additive | (ppm) |
| 1 | 10 | — | — |
| 2 | 10 | — | — |
| 3 | 10 | phosphoric acid | 2000 |
| 4 | 10 | formic acid | 2000 |
| 5 | 10 | sodium p-methyl | 2000 |
| | | benzoate | |
| 6 | 10 | potassium p-methyl | 2000 |
| | | benzoate | |
| 7 | 10 | zinc p-methyl | 2000 |
| | | benzoate | |
| 8 | 10 | calcium p-methyl | 2000 |
| | | benzoate | |
| 9 | 10 | citric acid | 2000 |
| 10 | 10 | citric acid | 2000 |
| 11 | 10 | p-methyl benzoic | 10000 |
| | | acid | |
| 12 | 10 | p-methyl benzoic | 20000 |
| | | acid | |
| 13 | 10 | benzoic acid | 2000 |
| 14 | 10 | benzoic acid | 2000 |

TABLE 2
Effects of different concentrations of p-methyl benzoic acid or its
calcium, sodium, potassium or zinc salt on growth promotion of
weaned pigs.

| | | Average | Feed | |
|---|---|---|---|---|
| | Number | daily weight | conversion | Diarrhea |
| Group | of animals | gain (g) | ratio | rate (%) |
| 1 | 10 | 173.1 | 1.67 | 28.0 |
| 2 | 10 | 181.7 | 1.69 | 25.0 |
| 3 | 10 | 175.3 | 1.66 | 27.0 |
| 4 | 10 | 173.4 | 1.65 | 25.0 |
| 5 | 10 | 203.7 | 1.55 | 17.0 |
| 6 | 10 | 205.8 | 1.58 | 15.0 |
| 7 | 10 | 201.3 | 1.60 | 15.0 |
| 8 | 10 | 203.6 | 1.54 | 12.0 |
| 9 | 10 | 181.3 | 1.67 | 31.0 |
| 10 | 10 | 180.4 | 1.68 | 26.0 |
| 11 | 10 | 215.8 | 1.51 | 11.0 |
| 12 | 10 | 221.4 | 1.47 | 9.0 |
| 13 | 10 | 192.3 | 1.66 | 22.0 |
| 14 | 10 | 193.5 | 1.65 | 23.0 |

The groups in Table 2 correspond to the groups in Table 1.

### Example 3

### Effects of p-methyl Benzoic Acid in the Feed for Ducks

300 Cherry Valley ducks aged 1 day were divided into 6 groups with 50 ducks per group. After adding different concentrations of p-methyl benzoic acid or benzoic acid into the same basic diet (without antibiotics) of each group, the Cherry Valley ducks were free feeding and drinking, and continued feeding for 30 days, then to collect statistics of the production performance and the survival rate of test ducks, the test grouping and metered concentrations are shown in Table 3, and the results of the production performance are shown in Table 4.

According to the test results, evidently, both the production performance and the survival rate of the group of p-methyl benzoic acid can be greatly improved, and its performance is distinctly superior to that of the groups of benzoic acid and formic acid.

TABLE 3
Grouping of feeding test of meat-type ducks and the concentration of
p-methyl benzoic acid in each group.

| Group | Compound | Concentration (ppm) |
|---|---|---|
| 1 | — | 0 |
| 2 | — | 0 |
| 3 | benzoic acid | 2000 |
| 4 | formic acid | 2000 |
| 5 | p-methyl benzoic acid | 2000 |
| 6 | p-methyl benzoic acid | 2000 |

TABLE 4
Effects of p-methyl benzoic acid in the feed for meat-type ducks.

| | Average initial | Average daily | Average feed | Survival |
|---|---|---|---|---|
| Group | weight | weight gain | conversion ratio | rate % |
| 1 | 51.2 | 56.1 | 2.17 | 91 |
| 2 | 51.2 | 57.2 | 2.18 | 90 |
| 3 | 51.2 | 59.7 | 2.10 | 92 |
| 4 | 51.2 | 58.6 | 2.11 | 93 |
| 5 | 51.2 | 64.5 | 2.03 | 100 |
| 6 | 51.2 | 66.2 | 2.01 | 100 |

The groups in table 4 correspond to the groups in Table 3.

### Example 4

### Effects of Calcium p-methyl Benzoate in the Feed for Grass Carps

The test was performed on an aquaculture farm of Guangzhou Insighter Biotechnology CO., LTD, and the test fish is grass carp. Healthy and lively grass carps with the same species and sizes were fed in a large cage for 4 weeks, thereafter used for formal test, and the test system is a small floating cage. The small floating cage and temporary cages were placed in a 3500 square meter pond of the test field. Water depth of the pond was close to 1.5m, and the pond water is fully aerated. When testing, 160 grass carps starved for 1 day were randomly divided into 4 groups, each group with 4 replicates, and each replicate with 10 fish. After the whole weighing, the samples were randomly placed in 16 cages and fed with different test diets. The test diets were self-formulated in accordance with Table 5, and the basic diets of different test groups were adding different growth promoters respectively. The test adopted artificial feeding with food restriction, and the feed intake was adjusted once a week, the feeding levels of two groups were completely consistent (metered by the initial weight), the fish in each group is fed two times in one day (7:30 and 15:00). The test lasted for 8 weeks.

The effects of fish with calcium p-methyl benzoate on growth promotion are shown in Table 5. The results show that the weight gain, feed conversion rate and survival rate of the group of calcium p-methyl benzoate were all better than that of blank control group; consequently, the group of calcium p-methyl benzoate has obvious effects on growth promotion.

TABLE 5
Test grouping and effects of calcium p-methyl benzoate in feed for
grass carps.

| | | Calcium | | |
|---|---|---|---|---|
| | | p-methyl | | |
| | Blank | benzoate/ | Benzoic acid/ | Citric acid/ |
| | control | 3000 ppm | 3000 ppm | 3000 ppm |
| Initial weight (g) | 236 | 238 | 237 | 236 |
| Final weight (g) | 580 | 612 | 585 | 582 |
| Weight gain rate | 145 | 157 | 147 | 147 |
| (%) | | | | |
| Feed conversion | 1.47 | 1.40 | 1.46 | 1.47 |
| ratio (FCR) | | | | |
| Survival rate SR | 100 | 100 | 100 | 100 |
| (%) | | | | |

### Example 5

### Effects of p-methyl Benzoic Acid and its Salts in Feed for Broilers

300 broilers (female seedlings) aged 1 day were divided into 6 groups in accordance with Table 6, and each group with 50 broilers. Acidifying agent with different type or concentration was added to the complete formula feed for chickens without any acidifying agents in each group, the broilers were free feeding and drinking during the test period of 21 days and then to collect statistics of the weight gain and the feed conversion ratio of test broiler in each test group. The results are shown in Table 7, it can be seen that the group of sodium p-methyl benzoate with the concentration of 2000 ppm can significantly increase the daily gain and improve the feed conversion ratio, however, the group of citric acid or sorbic acid with the concentration of 2000 ppm has no such effects.

TABLE 6
Grouping of growth promotion test of broilers with different
concentrations of acidifying agents, p-methyl benzoic acid or
its sodium salt.

| | Number | | Concentration |
|---|---|---|---|
| Group | of animals | Additive | (ppm) |
| 1 | 50 | — | 0 |
| 2 | 50 | — | 0 |
| 3 | 50 | p-methyl benzoic | 2000 |
| | | acid | |
| 4 | 50 | sodium p-methyl | 2000 |
| | | benzoate | |
| 5 | 50 | sorbic acid | 2000 |
| 6 | 50 | citric acid | 2000 |

TABLE 7
Effects of different concentrations of sodium p-methyl benzoate on
growth promotion of broilers.

| | | | Average | Feed |
|---|---|---|---|---|
| | Number | Additive and | daily weight | conversion |
| Group | of animals | Concentration/ppm | gain (g) | ratio |
| 1 | 50 | — | 20.3 | 1.89 |
| 2 | 50 | — | 20.8 | 1.89 |
| 3 | 50 | p-methyl benzoic | 24.5 | 1.76 |
| | | acid | | |
| 4 | 50 | sodium p-methyl | 24.3 | 1.79 |
| | | benzoate | | |
| 5 | 50 | sorbic acid | 19.9 | 1.89 |
| 6 | 50 | citric acid | 19.8 | 1.88 |

The groups in Table 7 correspond to the groups in Table 6.

1. Use of p-methyl benzoic acid or a salt thereof as an additive for a feed for animal.

2. The use of claim 1, wherein the additive for the feed for animal is a growth promoter for animal.

3. The use of claim 1, wherein the additive for the feed for animal is an acidifying agent.

4. The use of claim 1, wherein the salt is a salt of p-methyl benzoic acid selected from calcium, zinc, sodium, or potassium salt.

5. The use of claim 4, wherein the calcium salt of p-methyl benzoic acid is a salt with p-methyl benzoic acid and calcium in a ratio of 2:1 by mole; the zinc salt of p-methyl benzoic acid is a salt with p-methyl benzoic acid and zinc in a ratio of 2:1 by mole; the sodium salt of p-methyl benzoic acid is a salt with p-methyl benzoic acid and sodium in a ratio of 1:1 by mole; the potassium salt of p-methyl benzoic acid is a salt with p-methyl benzoic acid and potassium in a ratio of 1:1 by mole.

6. The use of claim 1, wherein the animal is pig, chicken, duck, or an aquatic animal.

7. The use of claim 1, wherein the concentration of p-methyl benzoic acid or a salt thereof in the feed for animal is from 1 ppm to 20000 ppm.

8. The use of claim 7, wherein the concentration of p-methyl benzoic acid or a salt thereof in the feed for animal is from 250 ppm to 10000 ppm.

9. The use of claim 1, wherein the use comprises adding p-methyl benzoic acid or a salt thereof into animal drinking water for animals to drink, and the concentration of p-methyl benzoic acid or a salt thereof is from 250 ppm to 10000 ppm.

10. The use of 2, wherein the salt is a salt of p-methyl benzoic acid selected from calcium, zinc, sodium, or potassium salt.

11. The use of claim 10, wherein the calcium salt of p-methyl benzoic acid is a salt with p-methyl benzoic acid and calcium in a ratio of 2:1 by mole; the zinc salt of p-methyl benzoic acid is a salt with p-methyl benzoic acid and zinc in a ratio of 2:1 by mole; the sodium salt of p-methyl benzoic acid is a salt with p-methyl benzoic acid and sodium in a ratio of 1:1 by mole; the potassium salt of p-methyl benzoic acid is a salt with p-methyl benzoic acid and potassium in a ratio of 1:1 by mole.

12. The use of claim 3, wherein the salt is a salt of p-methyl benzoic acid selected from calcium, zinc, sodium, or potassium salt.

13. The use of claim 12, wherein the calcium salt of p-methyl benzoic acid is a salt with p-methyl benzoic acid and calcium in a ratio of 2:1 by mole; the zinc salt of p-methyl benzoic acid is a salt with p-methyl benzoic acid and zinc in a ratio of 2:1 by mole; the sodium salt of p-methyl benzoic acid is a salt with p-methyl benzoic acid and sodium in a ratio of 1:1 by mole; the potassium salt of p-methyl benzoic acid is a salt with p-methyl benzoic acid and potassium in a ratio of 1:1 by mole.
